(19) United States
(12) Patent Application Publication
(10) Pub. No.: US 2024/0241886 A1
(43) Pub. Date: Jul. 18, 2024

(54) DATA CONVERSION APPARATUS, DATA CONVERSION METHOD AND PROGRAM

(71) Applicant: Nippon Telegraph and Telephone Corporation, Tokyo (JP)

(72) Inventors: Yuichi SUTO, Musashino-shi, Tokyo (JP); Ryosuke SATO, Musashino-shi, Tokyo (JP); Kei TAKESHITA, Musashino-shi, Tokyo (JP); Yuichiro ISHIZUKA, Musashino-shi, Tokyo (JP)

(21) Appl. No.: 18/561,925

(22) PCT Filed: May 18, 2021
(86) PCT No.: PCT/JP2021/018816

§ 371 Date: Nov. 17, 2023

(51) Int. Cl. G06F 16/25; G06F 16/35; G06F 40/166; G06F 40/30

(52) U.S. Cl. CPC G06F 16/258; G06F 16/355; G06F 40/166; G06F 40/30

(57) ABSTRACT

Provided is a data conversion device 1 that converts log data into structured data, the device including:
a determination unit 21 configured to determine, based on an appearance frequency of natural or non-natural language characters appearing in a document, whether the log data is first log data written in a natural language or second log data output mechanically output from a device;
a classification unit 25 configured to generate a classifier for classifying first log data into a category based on several pieces of first log data, as well as a plurality of categories, classify each piece of first log data into one of the plurality of categories using the classifier, and assign a vector obtained by vectorizing the meaning of a word contained in the several pieces of first log data;
a generation unit 26 configured to replace a plurality of words with a specific word, wherein the plurality of words have a vector similarity not less than a threshold and are regarded as the same word, among a plurality of words contained in the several pieces of first log data, for each category, and to generate log data composed of sentences shared by the several pieces of post-replacement first log data as a category template; and
a second extraction unit 22 configured to specify, in a case where it is determined that to-be-converted log data is the first log data, a category into which the to-be-converted log data will be classified using the classifier, to extract a unique variable for the to-be-converted log data by comparing the to-be-converted log data and a category template of the specified category, and to output the category template and the unique variable as structured data of the to-be-converted log data.

### TECHNICAL FIELD

The present invention relates to a data conversion device, a data conversion method and a data conversion program.

### BACKGROUND ART

For effectively exploiting data in artificial intelligence (AI), it is necessary to convert data into structured data. However, there may be unstructured raw data only. Examples of such unstructured raw data include operation log data recorded when setting a device. Specific examples include natural language log data (such as setting and troubleshooting procedures) which is a working history input manually when a worker sets a device or performs troubleshooting maintenance, or system log data (such as syslog) that a device mechanically outputs after a worker's setting.

Non Patent Literature 1 discloses that system log data mechanically output from a device is divided into a common component which is shared by several pieces of system log data and considered as a template of the system log data, and a unique variable which is different for each piece of system log data, and the template and the unique variable are used as structured data of the system log data.

### CITATION LIST

### Non Patent Literature

Non Patent Literature 1: Kimura, et al., “Spatio-temporal Factorization of Log Data for Understanding Network Events”, NTT, INFOCOM 2014

### SUMMARY OF INVENTION

### Technical Problem

However, NPL 1 has drawbacks that, since the common component (template) is generated based on appearing frequency of words contained in the system log data, when the method is applied to the natural language log data containing lots of natural language words, words having varying expressions but the same meaning cannot be accurately specified, thus it is difficult to convert the natural language log data into structure data. Therefore, manual conversion is the only option for the natural language log data, and thus specific knowledge and labor are required.

The present invention has been made to address the problems above, and an object of the present invention is to provide a technology capable of converting natural language data into structured data.

### Solution to Problem

A data conversion device according to one aspect of the present invention is a data conversion device that converts log data into structured data, the device including:
a determination unit configured to determine, based on an appearance frequency of natural or non-natural language characters appearing in a document, whether the log data is first log data written in a natural language or second log data output mechanically output from a device;
a classification unit configured to generate a classifier for classifying first log data into a category based on several pieces of first log data, as well as a plurality of categories, classify each piece of first log data into one of the plurality of categories using the classifier, and assign a vector obtained by vectorizing the meaning of a word contained in the several pieces of first log data to each word;
a generation unit configured to replace a plurality of words with a specific word, wherein the plurality of words have a vector similarity not less than a threshold and are regarded as the same word, among a plurality of words contained in the several pieces of first log data, for each category, and to generate log data composed of sentences shared by the several pieces of post-replacement first log data as a category template; and
an extraction unit configured to specify, in a case where it is determined that to-be-converted log data is the first log data, a category into which the to-be-converted log data will be classified using the classifier, to extract a unique variable for the to-be-converted log data by comparing the to-be-converted log data and a category template of the specified category, and to output the category template and the unique variable as structured data of the to-be-converted log data.

A data conversion method according to one aspect of the present invention is a data conversion method for converting log data into structured data, the method causing a data conversion device to:
determine based on an appearance frequency of natural or non-natural language characters appearing in a document, whether the log data is first log data written in a natural language or second log data output mechanically output from a device;
generate a classifier for classifying first log data into a category based on several pieces of first log data, as well as a plurality of categories, classify each piece of first log data into one of the plurality of categories using the classifier, and assign a vector obtained by vectorizing the meaning of a word contained in the several pieces of first log data to each word;
replace a plurality of words with a specific word, wherein the plurality of words have a vector similarity not less than a threshold and are regarded as the same word, among a plurality of words contained in the several pieces of first log data, for each category, and to generate log data composed of sentences shared by the several pieces of post-replacement first log data as a category template; and
specify, in a case where it is determined that to-be-converted log data is the first log data, a category into which the to-be-converted log data will be classified using the classifier, extract a unique variable for the to-be-converted log data by comparing the to-be-converted log data and a category template of the specified category, and output the category template and the unique variable as structured data of the to-be-converted log data.

A data conversion program according to one aspect of the present invention causes a computer to function as the data conversion device described above.

### Advantageous Effects of Invention

According to the present invention, it is possible to provide a technology capable of converting natural language log data into structured data.

### BRIEF DESCRIPTION OF DRAWINGS

FIG. 1 is a diagram illustrating an exemplified configuration of a data conversion device.

FIG. 2 is a diagram illustrating a specific exemplified configuration of the data conversion device.

FIG. 3 is a diagram illustrating a data example of system log data.

FIG. 4 is a diagram illustrating a data example of natural language log data.

FIG. 5 is a diagram illustrating exemplified classification of natural language log data.

FIG. 6 is a diagram illustrating exemplified generation of a template for natural language log data.

FIG. 7 is a diagram illustrating exemplified extraction of a unique variable.

FIG. 8 is a diagram illustrating a specific example of extraction method for a unique variable.

FIG. 9 is a diagram illustrating exemplified association between natural language log data and system log data.

FIG. 10 is a diagram illustrating a processing flow of the data conversion device.

FIG. 11 is a diagram illustrating exemplified determination for log data.

FIG. 12 is a diagram illustrating exemplified generation of a classifier and exemplified classification for natural language log data.

FIG. 13 is a diagram illustrating exemplified generation of a template for natural language log data.

FIG. 14 is a diagram illustrating exemplified generation of a template for natural language log data.

FIG. 15 is a diagram illustrating exemplified generation of a template for natural language log data.

FIG. 16 is a diagram illustrating exemplified conversion of natural language log data into structured data.

FIG. 17 is a diagram illustrating exemplified association between natural language log data and system log data.

FIG. 18 is a diagram illustrating an exemplified hardware configuration of the data conversion device.

### DESCRIPTION OF EMBODIMENTS

Hereinafter, an embodiment of the present invention will be described with reference to the drawings. The same elements are denoted by the same reference signs in the drawings, and descriptions thereof will be omitted.

### SUMMARY OF INVENTION

An object of the present invention is to convert natural language log data into structured data so that AI-based learning can be continuously executed without increasing costs. For achieving the object, the present invention discloses a system that extracts a common component (template) shared by several pieces of natural language log data while removing varying expressions from the natural language log data, and also extracts a unique variable different for each piece of natural language log data. AI-based learning is one example of exploitation of structured data.

It is a further object of the present invention to improve data quality for AI training data. For achieving the further object, the present invention associates natural language log data with system log data output mechanically using the extracted unique variable as a comparison condition. Therefore, as compared with a conventional method for extracting structured data from system log data only, it is possible to further convert natural language data into structured data, thereby improving quality of AI training data.

### [Exemplified Configuration of Data Conversion Device]

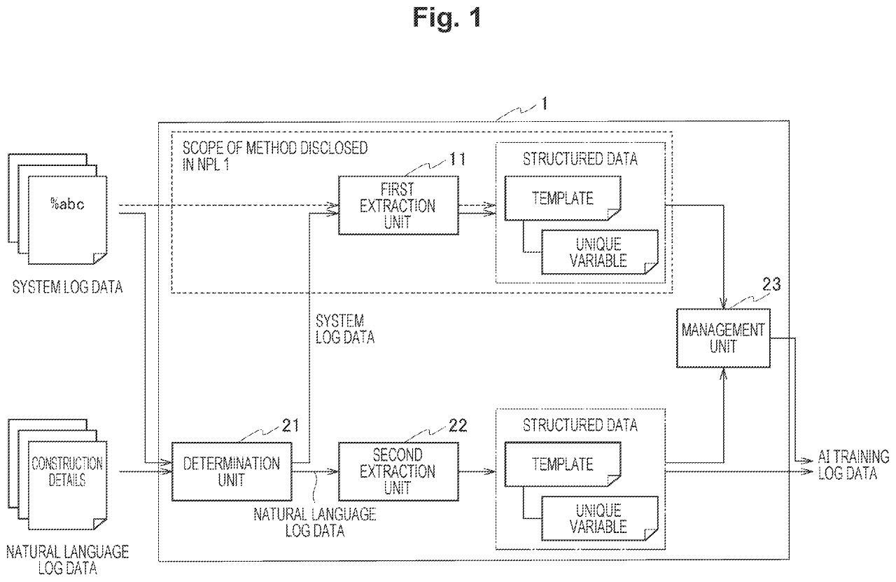

FIG. 1 is a diagram illustrating an exemplified configuration of a data conversion device according to the present embodiment.

A data conversion device 1 is configured by extending a configuration and a method disclosed in NPL 1. NPL 1 discloses that system log data mechanically output from a device is subject to conversion, and a first extraction unit 11 extracts from the system log data a common component (template) which is shared by several pieces of system log data, and a unique variable which is different for each piece of system log data, on the basis of the appearing frequency of words, whereby the template and the unique variable are used as structured data of the system log data.

The present embodiment is to scale up the configuration and the method disclosed in NPL 1 for further handling natural language log data that an operator manually inputs in a natural language. That is, the data conversion device 1 according to the present embodiment can accept both system log data and natural language log data, including a determination unit 21 that determines a data type of the input log data; a second extraction unit 22 that analyzes natural language log data with a proper method and extracts structured data; and a management unit 23 that associates system log data and natural language data in association with each other based on values of unique variables of structured data, respectively extracted from the first extraction unit 11 and the second extraction unit 22, in addition to the configuration disclosed in NPL 1.

In particular, the determination unit 21 has a function of determining the data type of the input log data based on a ratio of character codes in the input document. The natural language log data usually contains multibyte characters since they are described in a natural language, for example, Japanese. On the other hand, the system log data contains characters that humans do not generally input (such as tab or ↓, which is a linefeed character corresponding to \n in hexadecimal). The determination unit 21 determines whether the input log data is natural language log data or system log data based on the ratios of multibyte characters, tab characters and linefeed characters contained in the input document.

That is, the determination unit 21 has a function of determining whether the log data is natural language log data (first log data) described in a natural language or system log data (second log data) mechanically output from a device, based on the appearance frequency of characters in a natural or non-natural language, appearing in the document. The determination unit 21 determines that the log data is natural language log data in a case where a case where a ratio of the number of multibyte characters to the number of characters in the log data is not less than a threshold, or otherwise, the log data is system log data in a case where a ratio of the number of specific control characters (e.g. tab or linefeed characters) to the number of characters in the log data is not less than a threshold.

The second extraction unit (extraction unit) 22, scaling up the invention disclosed in NPL 1, has a function of analyzing meanings of words, considering a plurality of words sharing the same meaning as the same word, extracting a template and a unique variable from the to-be-converted natural language log data, and outputting the template and the unique variable as structured data of the natural language log data.

The first extraction unit 11 disclosed in NPL 1 generates the template of the log data based on the appearance frequency of words, while the second extraction unit 22 according to the present embodiment generates the template regarding a plurality of words having similar meaning as the same word. Therefore, it is possible to appropriately generate structured data from even natural language log data consisting of many natural languages.

The management unit 23 has a function of managing the natural language log data and the system log data in association with each other on the basis of the extracted unique variables such as a device name and IP address, and outputting structured data in which structured data of the natural language log data and structured data of the system log data are associated with each other.

### [Specific Exemplified Configuration of Data Conversion Device]

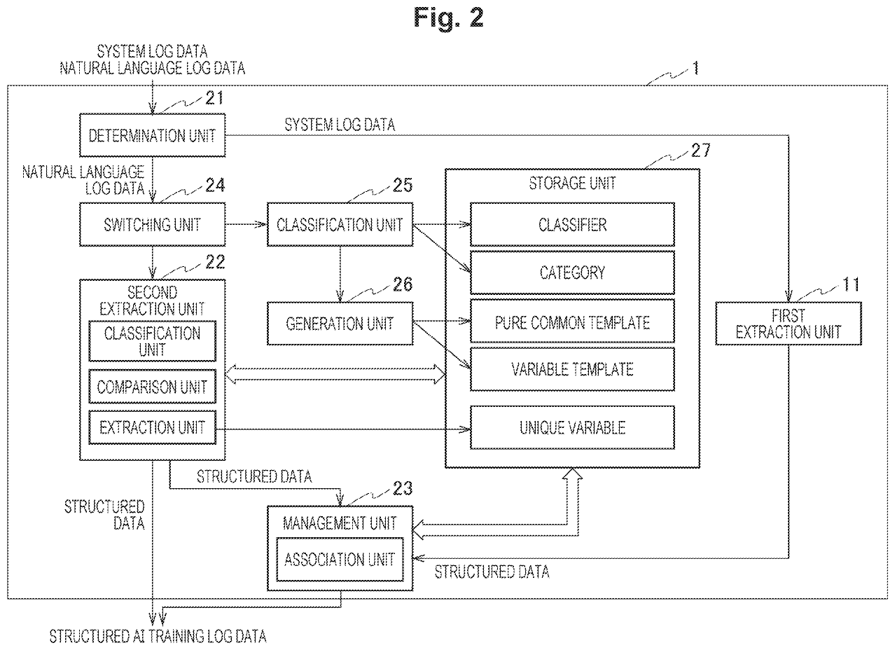

FIG. 2 is a diagram illustrating a specific exemplified configuration of the data conversion device 1 according to the present embodiment.

The data conversion device 1 executes step 1 of performing advanced preparation for the natural language log data using several pieces of past natural language log data, and step 2 of converting new natural language log data into structured data. For switching between step 1 and step 2, the data conversion devices 1 further includes a switching unit 24 in a preceding stage of the second extraction unit 22.

For executing step 1, the data conversion device 1 further includes a classification unit 25 that classifies several pieces of past natural language log data into predetermined categories, a generation unit 26 that generates a template of the natural language log data in each category, and a storage unit 27 that stores a classifier for the natural language log data, category information of each category, and the template.

In particular, the classification unit 25 has a function of generating a classifier for classifying the natural language log data into categories and a plurality of categories based on several pieces of past natural language log data; classifying the pieces of past natural language log data into any category of the plurality of categories using the classifier; and allocating a vector obtained by vectorizing the meaning of a word to each word contained in the pieces of past natural language log data.

The generation unit 26 has a function of replacing words with any one of the words (for example, a word with higher or lower appearing frequency), in which the words have a vector similarity not less than a threshold and are regarded as the same word, among words contained in the pieces of past natural language log data; and generating log data composed of sentences shared by the pieces of post-replacement past natural language log data as a category template, for each category.

Moreover, the generation unit 26 has a function of generating, as the template, a pure common template composed only of sentences shared by the pieces of post-replacement natural language log data, and a variable template, which is obtained by comparing the pure common template with the pieces of post-replacement natural language log data, specifying a different variable for each piece of natural language log data, and embedding symbols acquired by encoding the variable into the pure common template.

For executing step 2, the data conversion device 1 includes a second extraction unit 22 that converts new natural language log data into structured data, and a management unit 23 that manages the new natural language log data and the system log data in association with each other.

In particular, the second extraction unit 22 has a function of specifying, in a case where it is determined that new log data (to-be-converted log data) is the natural language log data, a category of the new log data using the classifier; comparing the new log data with a template of the category to extract a unique variable of the new log data; and outputting the category template and the unique variable as structured data of the new log data.

Moreover, the second extraction unit 22 allocates a vector obtained by vectorizing a meaning of a word to each word contained in the new log data; replaces words with a vector similarity not less than a threshold, among a plurality of words contained in the new log data, with any one of the words (for example, a word with higher or lower appearing frequency), considering those words as the same word; and compares the post-replacement new log data with the category template.

The management unit 23 has a function of managing the new log data (to-be-converted log data) and the system log data in association with each other, in a case where the new log data and the system log data have the same unique variable; and outputting structured data in which structured data of the to-be-converted log data and structured data of the system log data are associated with each other.

The names of the functional units illustrated in FIG. 2 may be replaced by, for example, a processing unit, an execution unit, and a processing execution unit. A plurality of functional units may be integrated into one functional unit, or alternatively, one functional unit may be divided into a plurality of functional units. For example, the classification unit 25 and the generation unit 26 may be integrated into one functional unit of the second extraction unit 22. The second extraction unit 22 and the management unit 23 may be combined as one functional unit and collectively named as a natural language log data conversion unit.

### [Log Data Determination Processing]

Natural language log data written in a natural language and manually input by an operator and system log data mechanically output from a device have larger number of specific characters used with respect to characters across the document. Therefore, the determination unit 21 measures a ratio of specific characters, compares the ratio of specific characters with a threshold, and determines a data type of the log data.

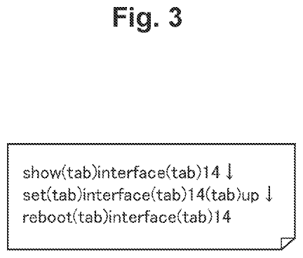

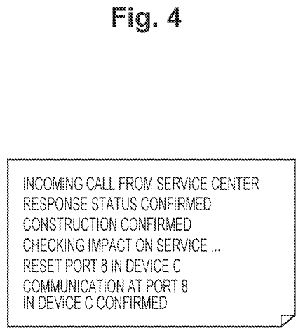

For example, the determination unit 21 determines that the input log data is the system log data output mechanically in a case where a ratio of characters that humans do not generally use (such as tab or ↓, which is a linefeed character corresponding to \n in hexadecimal) is higher than a threshold (see FIG. 3). Meanwhile, the determination unit 21 determines that the input log data is the natural language data in a case where a ratio of characters that humans generally use (such as multibyte characters) (see FIG. 4).

The determination unit 21 functions in both step 1 and step 2.

### [Template Generation Processing and Unique Variable Extraction Processing]

Template generation processing is executed in step 1 for advanced preparation. Extraction processing of template and unique variable is executed in step 2 for converting new natural language log data into structured data.

### [Step 1: Template Generation Processing]

In step 1, several pieces of natural language log data are classified into similar categories by arbitrary means. For the natural language log data for each category, the method disclosed in NPL 1 can be adopted by regarding words with similar meanings as the same word using a vector for each word, thereby generating structured data (template) representing the category. Details will be described below.

The classification unit 25 classifies several pieces of natural language log data into categories.

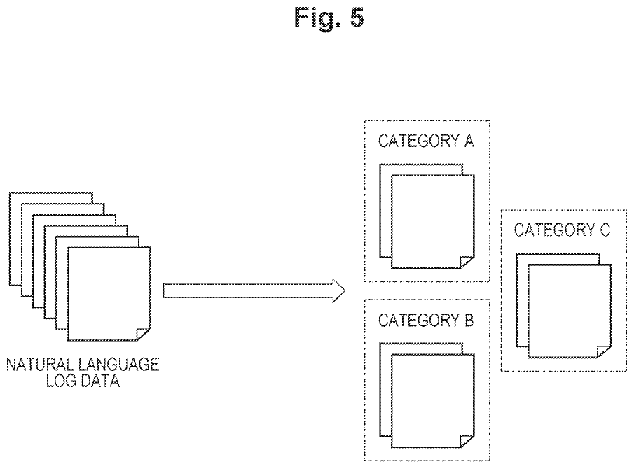

For example, the classification unit 25 inputs several pieces of natural language log data to a natural language deep learning model (for example, LDA: Latent Dirichlet Allocation), causes the deep learning modal to learn a format of log data and a meaning of a word, and classifies pieces of similar natural language log data into the same category (see FIG. 5). At this time, the classification unit 25 generates a classifier and several types of categories for classifying the natural language log data into categories. The classification unit 25 allocates a vector obtained by vectorizing a meaning of a word to each word contained in the pieces of natural language log data.

For the natural language log data in each category, the generation unit 26 regards words having similar meanings as the same word using the vector of each word, and generates a natural language log data template representing each category based on appearing frequency of words, in the same manner as in the first extraction unit 11 disclosed in NPL 1.

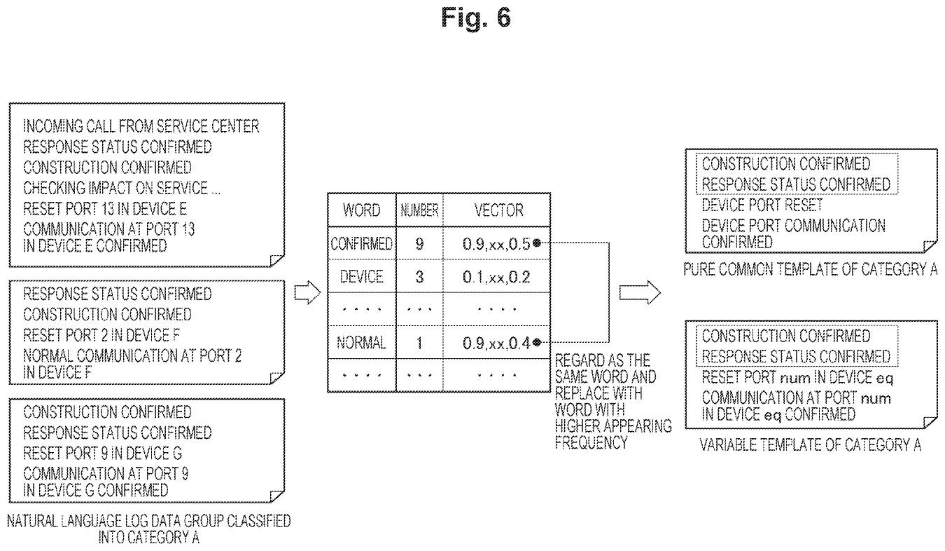

For example, the generation unit 26 performs morphological analysis of natural language log data for each category and counts the number of words to measure appearing frequency of words for each category. At that time, the generation unit 26 regards a plurality of words in which a similarity of vectors allocated to respective words is not less than a threshold as the same word, and for example, replaces those words with a word with higher appearing frequency. Similarly to the method disclosed in NPL 1, the generation unit 26 divides the natural language log data in the same category into a common component shared by the pieces of natural language log data and a unique variable different for each piece of natural language log data, and generates a pure common template corresponding to common structured data and a variable template in which a symbol with a variable is embedded into the pure common template (see FIG. 6).

The generation unit 26 obtains a sentence vector of each sentence contained in the pieces of natural language log data and generates a list of sentence vectors previously appearing. At this time, the generation unit 26 considers that a sentence vector a and a sentence vector B with the sentence vector a as a reference sentence vector a have a different order, encloses the two sentence vectors a and B (“construction confirmed” and “response status confirmed” illustrated in FIG. 6) with blocks, and defines them as a block representing a different-order relationship.

### [Step 2: Extraction Processing of Template and Unique Variable]

In step 2, a category to which the new natural language log data belongs is determined. If there is a category to which the unique variable belongs, the unique variable is extracted from the new natural language log data while being compared with the category template and converting the new natural language log data into structured data. In a case where words has a high vector similarity, the words are regarded as the same word. Details will be described below.

The second extraction unit 22 specifies the category to which the new natural language log data input to the data conversion device 1 belongs using the classifier. In a case where the category to which the log data belongs cannot be specified, the second extraction unit 22 prompts a user of the data conversion device 1 to designate the category, or alternatively, creates a new category.

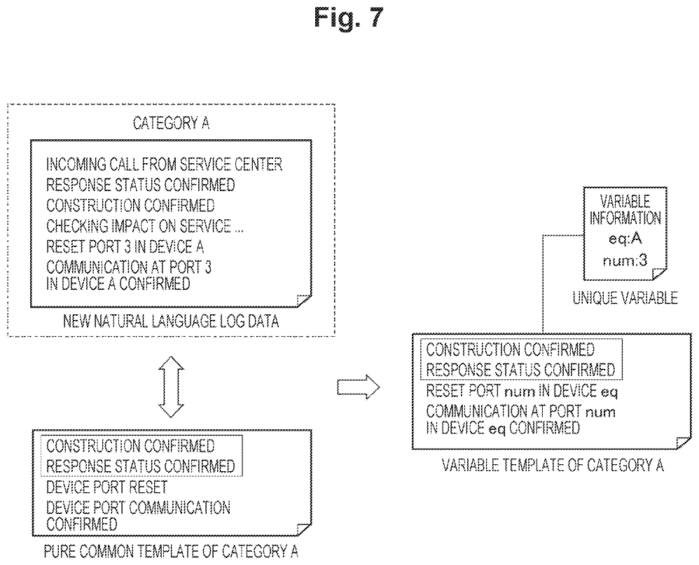

If there is a category to which the unique variable can belong, the second extraction unit 22 compares the new natural language log data with the category template, and converts the new natural language log data into structured data while extracting a unique variable from the new natural language log data (see FIG. 7). At that time, the second extraction unit 22 allocates a vector obtained by vectorizing the meaning of a word to each word contained in the new natural language log data, and regards a plurality of words having a vector similarity not less than a threshold among a plurality of words contained in the new natural language log data as the same word.

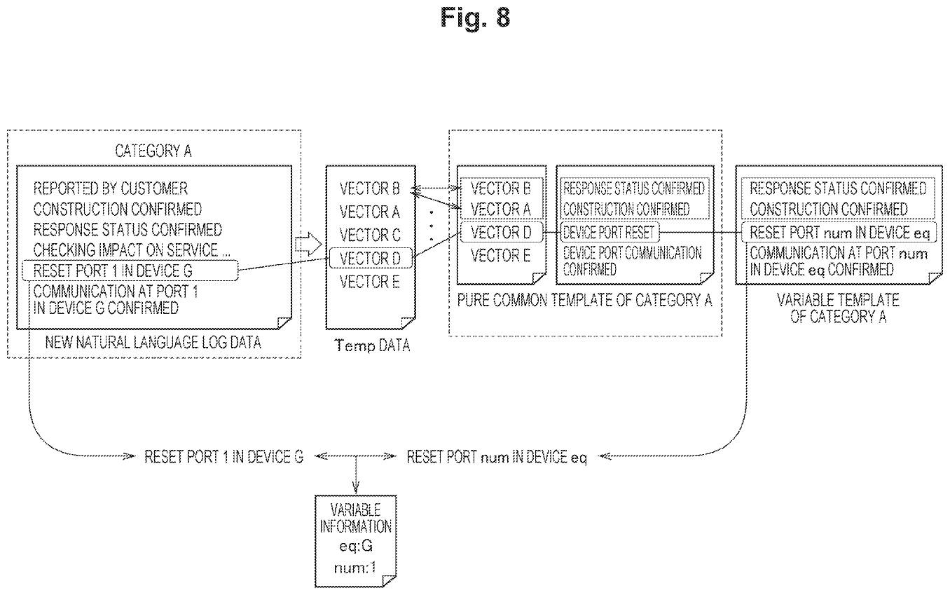

For example, for the new natural language log data belonging to a category A, the second extraction unit 22 configures Temp data in which each sentence contained in the new natural language log data is represented only by a high-order word having higher appearance frequency, and vectorizes each sentence contained in the Temp data with doc2vec. The second extraction unit 22 compares each vector of the Temp data with a vector of each sentence in the pure common template of the category A calculated when generating the pure common template in order from the top. At that time, the particles in the sentence are removed, and a plurality of words having a vector similarity not less than a threshold are regarded as the same word and replaced with, for example, a word with higher appearing frequency. In a case where sentences have a high vector similarity, a sentence in a variable template of the category A, corresponding to the vector, is compared with a sentence contained in the new natural language log data, thereby extracting a unique variable component from the new natural language log data (see FIG. 8).

The second extraction unit 22 outputs the unique variable and the variable template to an AI-based learning machine as the structured data of the new natural language log data.

### [Association Processing Between Natural Language Log Data and System Log Data]

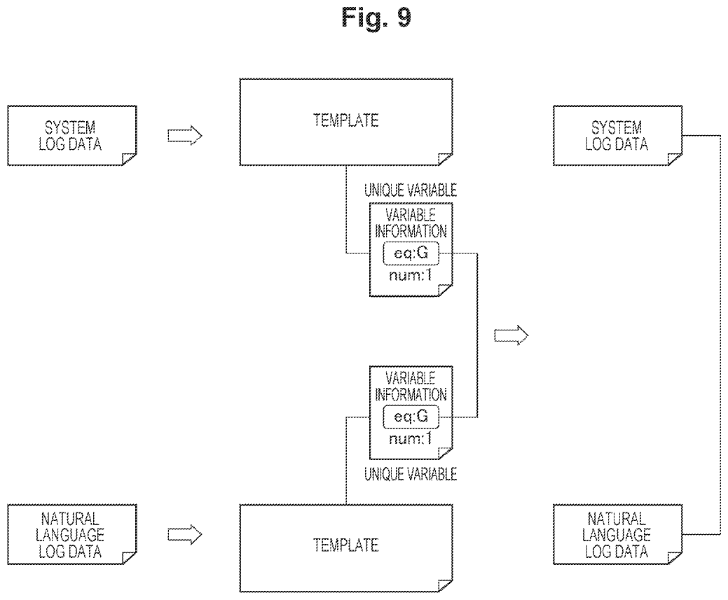

The management unit 23 manages the natural language log data and the system log data in association with each other on the basis of the comparison results between unique variables in the log data, and outputs the structured data in which structured data of the natural language log data and structured data of the system log data are associated with each other (see FIG. 9). Accordingly, it is possible to complement each other with information on setting or troubleshooting in a device, which cannot be obtained from a single piece of log data. Association between pieces of log data is not limited to one-to-one, but includes several variations such as one-to-many or many-to-many. Moreover, the association processing may use a timestamp of the log data in addition to unique variable values.

### [Operations of Data Conversion Device]

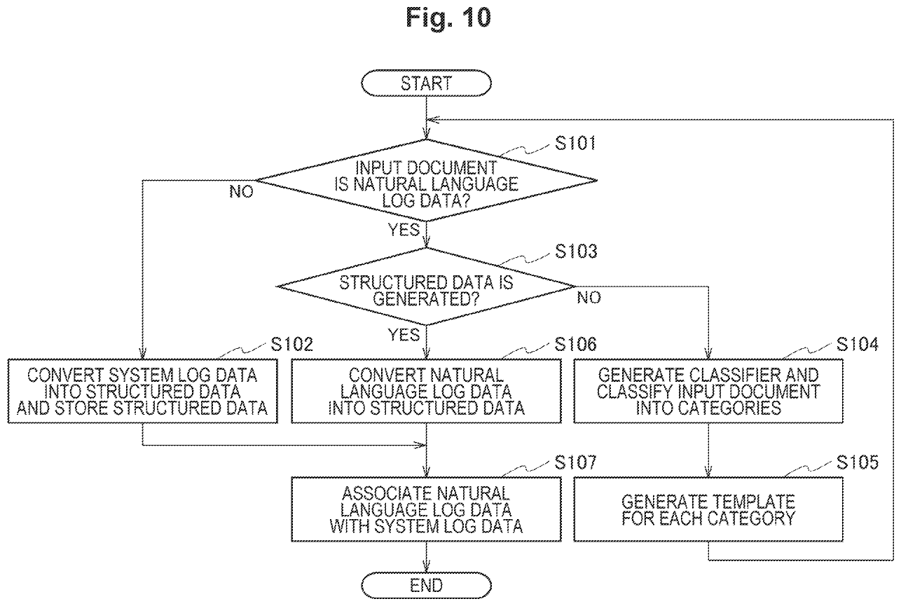

FIG. 10 is a diagram illustrating a processing flow of the data conversion device.

### Step S101:

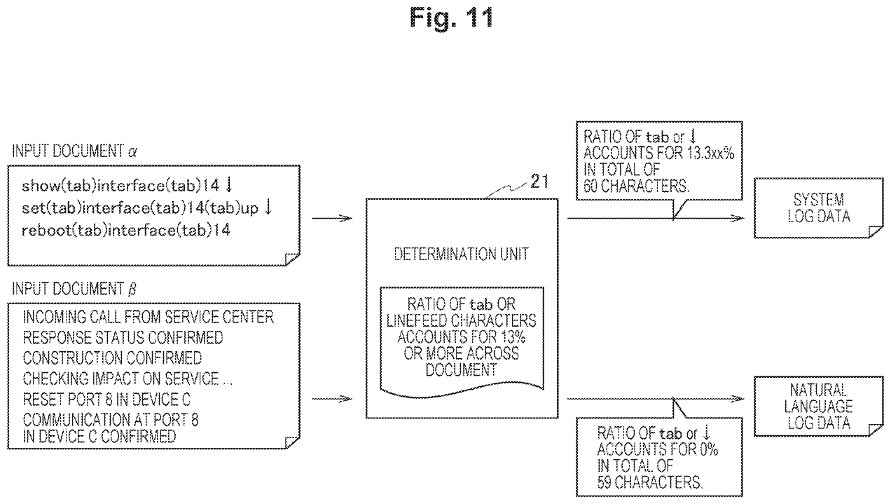

The determination unit 21 determines whether the input document is natural language log data or system data log output mechanically. For example, the determination unit 21 determines a log data type by comparing a ratio of specific characters across the document with a threshold. In particular, as illustrated in FIG. 11, the determination unit 21 determines that, based on a rule that “a ratio of tab or linefeed characters accounts for at least 13% across the document”, the log data is natural language log data in a case where the input documents satisfies the rule, and otherwise, the log data is system log data. The comparison rule may be a single rule or a combinations of several rules.

### Step S102:

In a case where the input document is system log data, the first extraction unit 11 extracts from the system log data a common component (template) which is shared by several pieces of system log data, and a unique variable which is different for each piece of system log data, outputs the template and the unique variable as structured data of the system log data, and stores them in the storage unit 27.

### Step S103:

In a case where the input document is natural language log data, the switching unit 24 determines whether the next step is step 1 of performing advanced preparation using several pieces of past natural language log data, or step 2 of converting new natural language log data into structured data. For example, the switching unit 24 determines the next step as designated by the user.

### Step S104:

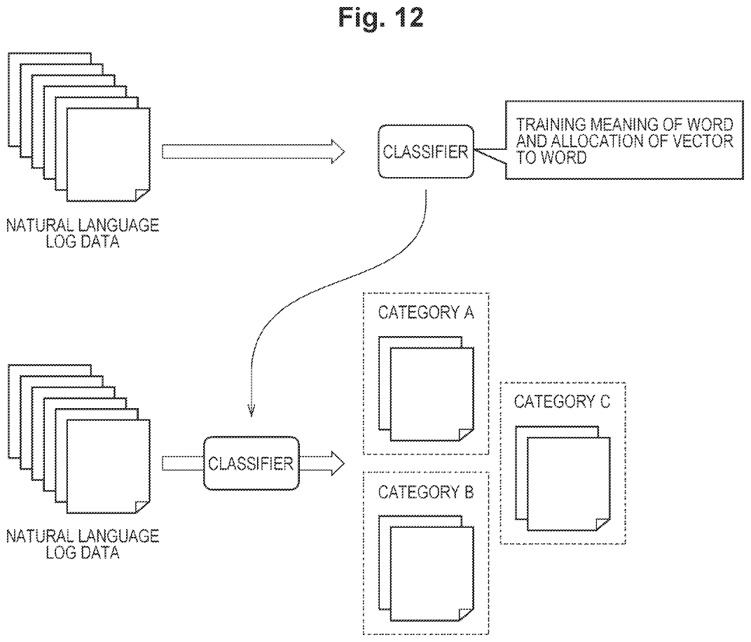

In a case where the next step is step 1 in step S103, the classification unit 15 inputs several pieces of natural language log data input to the data conversion device 1 into a natural language deep learning model, as illustrated in FIG. 12, allocates a vector to a word while training meanings of words using an algorithm such as skip-gram, generates a classifier for classifying natural language log data into categories and a plurality of categories, and stores them in the storage unit 27. The classification unit 15 classifies the pieces of natural language log data input to the data conversion device 1 into predetermine categories using the classifier.

### Step S105:

After executing step S104, the generation unit 26 generates a natural language log data template representing each category. The processing returns to step S101. Hereinafter, a template generation method will be described in detail.

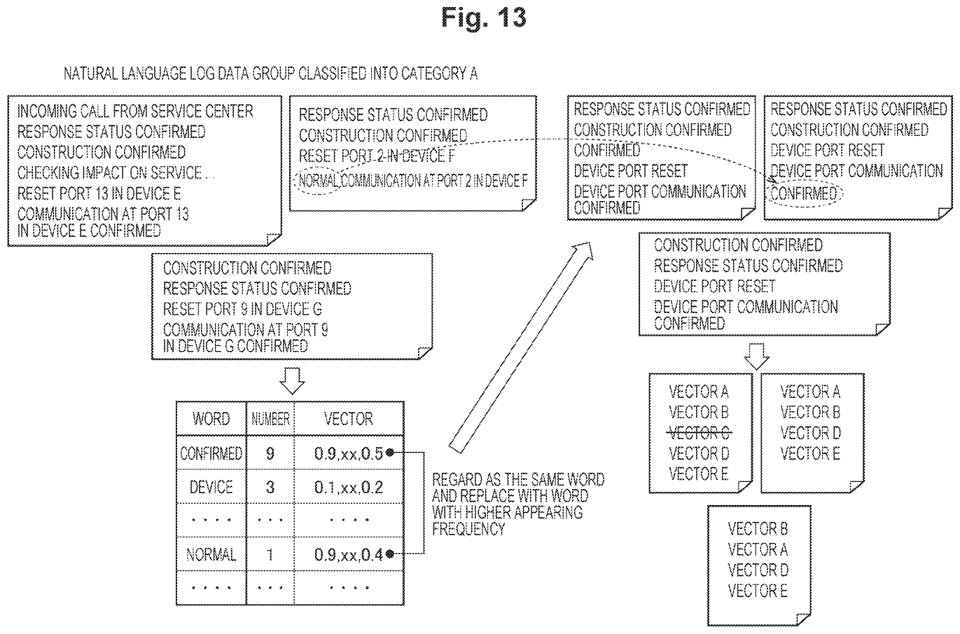

The generation unit 26 performs morphological analysis on the pieces of natural language log data belonging to the same category, and measures appearance frequency of words while removing the particles, as illustrated in FIG. 13.

The generation unit 26 removes particles from each piece of natural language log data and generates a document including only words having frequency not less than a threshold. At that time, the generation unit 26 regards a plurality of words in which a vector similarity is not less than a threshold as the same word, and for example, replaces those words with a word with higher frequency. As described above, since a plurality of words having a vector similarity not less than a threshold are regarded as the same word, the natural language log data in many natural languages can be appropriately structured.

Subsequently, the generation unit 26 vectorizes each sentence in the pieces of post-replacement natural language log data with doc2vec, thereby processing each sentence in the pieces of natural language log data into a format in which inter-data comparison can be easily performed. The generation unit 26 counts the number of the same sentence vectors in all pieces of natural language log data, and removes the sentence vector having appearance frequency lower than the threshold.

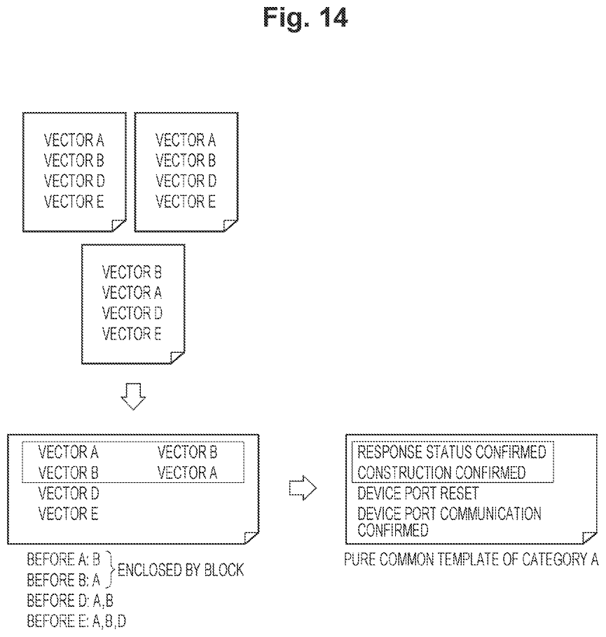

As illustrated in FIG. 14, the generation unit 26 analyzes the order of appearance between sentence vectors. Specifically, the generation unit 26 generates a list of sentence vectors previously appearing for each sentence vector contained in the pieces of natural language log data. At this time, the generation unit 26 considers that a sentence vector a and a sentence vector B with the sentence vector a as a reference sentence vector a have a different order, encloses the two sentence vectors a and B with blocks, and defines them as blocks representing a different-order relationship. The block representing a different-order relationship may be defined by the user. The generation unit 26 stores the document subjected to the order analysis in the storage unit 27 as a pure common template.

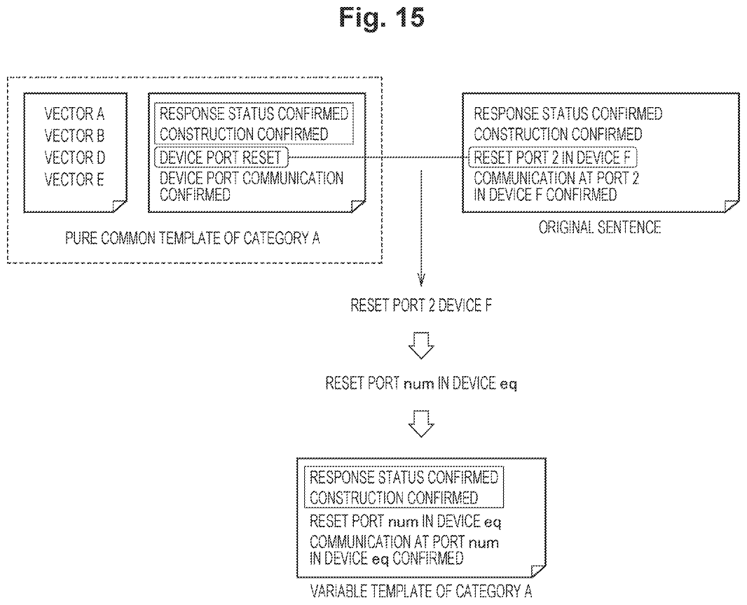

As illustrated in FIG. 15, the generation unit 26 compares the pure common template with the original natural language log data, excludes particles, and extracts a component corresponding to the variable from the original natural language log data. In particular, the generation unit 26 compares words from the first word for each sentence, and extracts an unmatched component as a variable from the sentence of the original natural language log data.

The generation unit 26 encodes the variable extracted from the sentence of the original natural language log data, converts the variable into a variable symbol, and embeds the variable symbol in the pure common template. The generation unit 26 executes similar processing for all the sentences, and stores the template with the variable symbol embedded in the storage unit 27 as a variable template. A variable symbol may be determined by automatic generation using, for example, a random number, or may be determined by the user.

The processing returns to step S101.

### Step S106:

In step S103, in a case where the next step is step 2, the second extraction unit 22 converts the new natural language log data into structured data. Details will be described below.

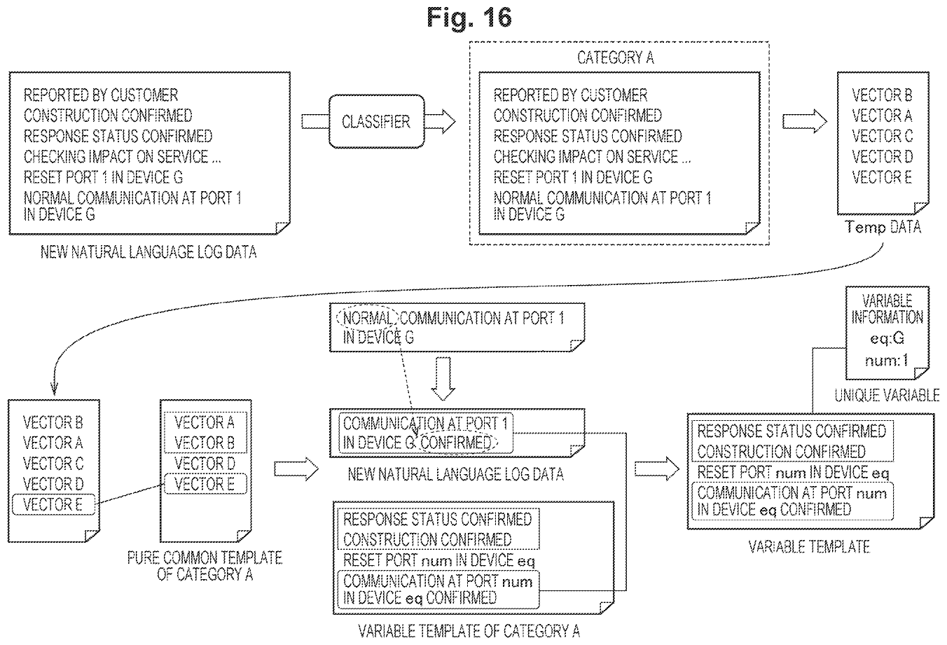

As illustrated in FIG. 16, the second extraction unit 22 reads a classifier from the storage unit 27, and specifies a category to which the new natural language data belongs using the classifier. In a case where the category to which the log data belongs cannot be specified, the second extraction unit 22 prompts a user of the data conversion device 1 to designate the category, or alternatively, creates a new category.

The second extraction unit 22 converts the new natural language log data into natural language data in which only words having higher appearance frequency are extracted, and vectorizes each sentence contained in the converted natural language data with, for example, word2vec to obtain Temp data.

The second extraction unit 22 compares the uppermost sentence vector in the Temp data with the uppermost sentence vector of a pure common template of the specified category, and removes the sentence vector when a matching level is low. The second extraction unit 22 sequentially compares sentence vectors from the uppermost sentence vector of the pure common template, compares the new natural language log data with a variable template of specified category for the sentence vector having the highest matching level, and extracts a variable component from the new natural language log data.

The second extraction unit 22 allocates a vector obtained by vectorizing a meaning of a word to each word contained in the new natural language log data. The second extraction unit 22 removes particles in the sentence, regards a plurality of words having a vector similarity not less than a threshold as the same word, and replaces those word with a word having higher appearing frequency. The second extraction unit 22 removes matched sentence vectors of the pure common template from to-be-compared vectors. Vectors contained in blocks in the pure common template are compared considering different orders.

The second extraction unit 22 executes similar processing on all the sentence vectors in the Temp data, and associates the extracted variable with the variable template. The second extraction unit 22 outputs the unique variable and the variable template as structured data of the new natural language log data.

### Step S107:

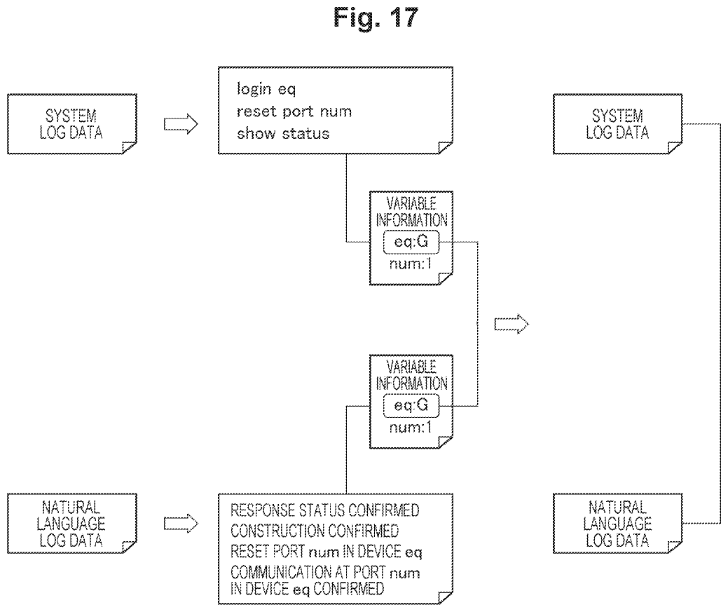

After step S106 is completed, as illustrated in FIG. 17, the management unit 23 compares the unique variable of the natural language log data, extracted by the second extraction unit 22, with the unique variable of the system log data, extracted by the first extraction unit 11, and manages the natural language log data and the system log data in association with each other in a case where the unique variables are the same. For example, in a case where device names (eq) of the unique variables are both “G”, the management unit 23 determines that those two pieces of log data are relevant, and associates the natural language log data with the system log data. The management unit 23 outputs structured data in which structured data of the natural language log data and structured data of the system log data are associated with each other to a display, a printer, a device, and other devices. Accordingly, it is possible to complement each other with task information which cannot be obtained from a single piece of log data.

### Advantageous Effects

According to the present embodiment, in the data conversion device 1, the generation unit 26 replaces words with any one of the words, in which the words have a vector similarity not less than a threshold and are regarded as the same word, among words contained in the pieces of past natural language log data; and generates log data composed of sentences shared by the pieces of post-replacement past natural language log data as a category template, whereby it is possible to provide a technology capable of converting natural language log data into structured data.

According to the present embodiment, in the data conversion device 1, the second extraction unit 22 allocates a vector obtained by vectorizing a meaning of a word to each word contained in the new natural language log data; replaces words with a vector similarity not less than a threshold, among a plurality of words contained in the new log data, with any one of the words, considering those words as the same word; and compares the post-replacement new natural language log data with the category template, whereby it is possible to provide a technology capable of converting natural language log data into structured data.

According to the present embodiment, in the data conversion device 1, the management unit 23 associates the natural language log data with the system log data output mechanically, thus it is possible to acquire structured data even from natural language log data as compared to a convention method that can extract structured data only from system log data, thereby improving quality of AI training data. [Others]

The present invention is not limited to the embodiment stated above. The present invention can be modified in various manners without departing from the gist of the present invention.

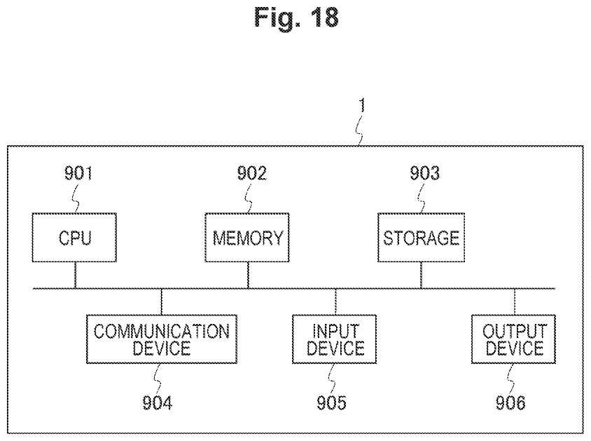

For example, a general-purpose computer system can be used to implement the data conversion device 1 of the present embodiment described above, including a CPU 901, a memory 902, a storage 903, a communication device 904, an input device 905, and an output device 906 as illustrated in FIG. 18. The memory 902 and the storage 903 are storage devices. In the computer system, each function of the data conversion device 1 is implemented by the CPU 901 executing a predetermined program loaded on the memory 902.

The data conversion device 1 may be implemented by a single computer. The data conversion device 1 may be implemented by a plurality of computers. The data conversion device 1 may be a virtual machine that is implemented in a computer. The program for the data conversion device 1 can be stored in a computer-readable recording medium such as HDD, SSD, USB memory, CD or DVD. The program for the data conversion device 1 can also be distributed via a communication network.

### REFERENCE SIGNS LIST

1 Data conversion device
11 First extraction unit
21 Determination unit
22 Second extraction unit
23 Management unit
24 Switching Unit
25 Classification unit
26 Generation unit
901 CPU
902 Memory
903 Storage
904 Communication device
905 Input device
906 Output device

1. A data conversion device configured to convert log data into structured data, the device comprising:
a determination unit, implemented using one or more computing devices, configured to determine, based on an appearance frequency of natural or non-natural language characters appearing in a document, whether the log data is first log data written in a natural language or second log data mechanically output from a device;
a classification unit, implemented using one or more computing devices, configured to:
generate a classifier for classifying the first log data into a category based on a plurality of pieces of the first log data, as well as a plurality of categories,
classify each piece of the first log data into one of the plurality of categories using the classifier, and
assign a vector obtained by vectorizing a meaning of a word included in the plurality of pieces of the first log data to each word;
a generation unit, implemented using one or more computing devices, configured to:
replace a plurality of words with a specific word, the plurality of words having a vector similarity greater than or equal to a threshold and being regarded as a same word, among a plurality of words included in the plurality of pieces of the first log data, for each category, and
generate log data composed of sentences shared by the plurality of pieces of post-replacement first log data as a category template; and
an extraction unit, implemented using one or more computing devices, configured to:
specify, based on a determination that to-be-converted log data is the first log data, a category into which the to-be-converted log data will be classified using the classifier,
extract a unique variable for the to-be-converted log data by comparing the to-be-converted log data and a category template of the specified category, and
output the category template and the unique variable as structured data of the to-be-converted log data.

2. The data conversion devices according to claim 1, further comprising
a management unit, implemented using one or more computing devices, configured to associate the to-be-converted log data and the second log data based on their unique variables aligning with each other.

3. The data conversion device according to claim 1, wherein the determination unit is configured to:
based on a ratio of a number of multibyte characters to a number of characters in the log data is greater than or equal to a threshold, determine that log data is the first log data a threshold, and
based on a ratio of a number of specific control characters to the number of characters in the log data being greater than or equal to a threshold, log data is the second log data.

4. The data conversion device according to claim 1, wherein the generation unit is configured to;
generate, as the template, a pure common template composed only of sentences shared by the plurality of pieces of post-replacement first log data, and a variable template, which is obtained by comparing the pure common template with the plurality of pieces of post-replacement first log data, specifying a different variable for each piece of first log data, and embedding symbols acquired by encoding the variable into the pure common template.

5. The data conversion device according to claim 1, wherein;
the extraction unit is configured to:
allocate a vector obtained by vectorizing a meaning of a word to each word contained in the to-be-converted log data;
replace words with a vector similarity greater or equal to a threshold, among a plurality of words included in the to-be-converted log data, with one of the words, considering those words as a same word; and
compare the post-replacement to-be-converted log data with the category template.

6. A data conversion method for converting log data into structured data, the method causing a data conversion device to:
determine, based on an appearance frequency of natural or non-natural language characters appearing in a document, whether the log data is first log data written in a natural language or second log data mechanically output from a device;
generate a classifier for classifying the first log data into a category based on a plurality of pieces of the first log data, as well as a plurality of categories, classify each piece of the first log data into one of the plurality of categories using the classifier, and assign a vector obtained by vectorizing a meaning of a word included in the plurality of pieces of the first log data to each word;
replace a plurality of words with a specific word, the plurality of words having a vector similarity greater than or equal to a threshold and being regarded as a same word, among a plurality of words included in the plurality of pieces of the first log data, for each category, and to generate log data composed of sentences shared by the plurality of pieces of post-replacement first log data as a category template; and
specify, based on a determination that to-be-converted log data is the first log data, a category into which the to-be-converted log data will be classified using the classifier, extract a unique variable for the to-be-converted log data by comparing the to-be-converted log data and a category template of the specified category, and output the category template and the unique variable as structured data of the to-be-converted log data.

7. A non-transitory computer readable medium storing a data conversion program that causes a computer to perform operations comprising:
determining, based on an appearance frequency of natural or non-natural language characters appearing in a document, whether log data is first log data written in a natural language or second log data mechanically output from a device;
generating a classifier for classifying the first log data into a category based on a plurality of pieces of the first log data, as well as a plurality of categories;
classifying each piece of the first log data into one of the plurality of categories using the classifier;
assigning a vector obtained by vectorizing a meaning of a word included in the plurality of pieces of the first log data to each word;
replacing a plurality of words with a specific word, the plurality of words having a vector similarity greater than or equal to a threshold and being regarded as a same word, among a plurality of words included in the plurality of pieces of the first log data, for each category;
generating log data composed of sentences shared by the plurality of pieces of post-replacement first log data as a category template;
specifying, based on a determination that to-be-converted log data is the first log data, a category into which the to-be-converted log data will be classified using the classifier;
extracting a unique variable for the to-be-converted log data by comparing the to-be-converted log data and a category template of the specified category; and
outputting the category template and the unique variable as structured data of the to-be-converted log data.
